(19) United States
(12) Patent Application Publication
(10) Pub. No.: US 2024/0028959 A1
(43) Pub. Date: Jan. 25, 2024

(54) AUTOMATIC SMOOTHING AND RE-BINNING FOR MACHINE LEARNING MODEL OUTPUT

(71) Applicant: DataRobot, Inc., Boston, MA (US)

(72) Inventors: Glen Koundry, Montgomery, MA (US); Mikhail Yakubovskiy, Brooklyn, NY (US)

(73) Assignee: DataRobot, Inc., Boston, MA (US)

(21) Appl. No.: 18/223,761

(22) Filed: Jul. 19, 2023

Related U.S. Application Data
(60) Provisional application No. 63/391,936, filed on Jul. 25, 2022.

(51) Int. Cl. G06N 20/00

(52) U.S. Cl. CPC G06N 20/00

(57) ABSTRACT

Re-binning and smoothing an indicator table is provided. A system can identify a table generated a model trained with machine learning, the table including bins for ranges of values of a feature and coefficients that indicate a level of a target for the bins. The system can receive, via a graphical user interface from a client device, a request to modify bins of the table. The system can establish, responsive to the request, a spline to fit the table based at least in part on a cost function weighted based on a number of entries of the feature for the ranges of values of the feature. The system can generate, via the spline established based at least in part on the cost function, a second table including second bins and second coefficients. The system can generate data to cause the graphical user interface to include a graphic representation of the second table.

### CROSS-REFERENCE TO RELATED PATENT APPLICATION

This application claims, under 35 U.S.C. § 119, the benefit of, and priority to, U.S. Provisional Patent Application No. 63/391,936 filed Jul. 25, 2022, the entirety of which is incorporated by reference herein.

### TECHNICAL FIELD

This disclosure relates generally to machine learning and post-processing techniques.

### BACKGROUND

A machine learning system can train models based on training datasets. The machine learning system can implement training techniques that determine values for various parameters or weights of the models. The models can execute on inference datasets to make model decisions, predictions, or other inferences based on the various values for the parameters or weights.

### SUMMARY

This technical solution is directed to a system to generate an indicator table through re-binning and smoothing. The system can perform post-processing on an indicator table generated by a model trained by machine learning to re-bin and smooth the indicator table. The post-processing can perform re-binning by fitting a spline to an indicator table. The system can run a computer process on an objective function, such as a cost function, to fit a spline to the bins and coefficients of the indicator table. The system can generate new coefficients and bins from the spline. The resulting new coefficients and bins can form a re-binned indicator table. By performing the re-binning and smoothing, a smoothed and increased resolution indicator table can be formed without increasing the size of the model trained by machine learning and sacrificing accuracy of the indicator table. The accuracy of the indicator table can decrease as a result of increasing the size of the model trained by machine learning to increase the smoothness resolution of the indicator table produced by the model. By improving the indicator table without increasing the size of the model trained by machine learning, this technical solution can provide a model that can be stored and processed while consuming less memory resources and processing power.

An aspect of this technical solution can be directed to a system that includes a data processing system including one or more processors, coupled with memory. The data processing system can identify a table generated by a model trained with machine learning, the table including bins for ranges of values of a feature and coefficients that indicate a level of a target for the bins. The data processing system can receive, via a graphical user interface from a client device, a request to modify bins of the table. The data processing system can establish, responsive to the request, a spline to fit the table based at least in part on a cost function weighted based on a number of entries of the feature for the ranges of values of the feature. The data processing system can generate, via the spline established based at least in part on the cost function, a second table including second bins and second coefficients. The data processing system can generate data to cause the graphical user interface to include a graphic representation of the second table.

The data processing system can generate a first bin for a first range of values of the feature of the second bins in a first resolution proportional to a first slope of the spline over the first range of values of the feature. The data processing system can generate a second bin for a second range of values of the feature of the second bins in a second resolution proportional to a second slope of the spline over the second range of values of the feature.

The data processing system can fit the spline to the table based on the cost function, the cost function can include a summation of distances between the second bins and lines of functions of the spline.

The data processing system can receive, via the graphical user interface from the client device, a first definition of a first set of parameters for a first feature. The data processing system can receive, via the graphical user interface from the client device, a second definition of a second set of parameters for a second feature. The data processing system can generate a first re-binned indicator table based on a first indicator table generated by machine learning for the first feature and the first set of parameters. The data processing system can generate a second re-binned indicator table based on a second indicator table generated by machine learning for the second feature and the second set of parameters.

The spline can include at least one first function of a first function type and at least one second function of a second function type.

The first function type can be linear and the second function type can be constant.

The data processing system can receive, via the graphical user interface from the client device, parameters defining the spline. The data processing system can generate the spline based on the parameters.

The parameters can include ranges for functions of the spline. The parameters can include function types for the ranges.

The data processing system can generate data to cause the graphical user interface to include an element to select between an automatic generation of the second indicator table and a manual generation of the second indicator table.

The data processing system can fit the spline to the table based on the cost function weighted based on the number of entries of the feature for the ranges of values of the feature responsive to a selection of the automatic generation by the client device via the graphical user interface.

The data processing system can generate the spline based on user defined parameters responsive to a selection of the manual generation of the second table.

The data processing system can receive the user defined parameters in a first format. The data processing system can compare the first format to a second format. The data processing system can generate data causing the graphical user interface to display an alert responsive to a determination of a difference between the first format and the second format.

At least one aspect is directed to a method. The method can include identifying, by a data processing system including one or more processors, coupled with memory, a table generated by a model trained with machine learning, the table including bins for ranges of values of a feature and coefficients that indicate a level of a target for the bins. The method can include receiving, by the data processing system, via a graphical user interface from a client device, a request to modify bins of the table. The method can include establishing, by the data processing system, responsive to the request, a spline to fit the table based at least in part on a cost function weighted based on a number of entries of the feature for the ranges of values of the feature. The method can include generating, by the data processing system, via the spline established based at least in part on the cost function, a second table including second bins and second coefficients. The method can include generating, by the data processing system, data to cause the graphical user interface to include a graphic representation of the second table.

The method can include generating, by the data processing system, a first bin for a first range of values of the feature of the second bins in a first resolution proportional to a first slope of the spline over the first range of values of the feature. The method can include generating, by the data processing system, a second bin for a second range of values of the feature of the second bins in a second resolution proportional to a second slope of the spline over the second range of values of the feature.

The method can include fitting, by the data processing system, the spline to the indicator table based on the cost function, the cost function including a summation of distances between the second bins and lines of functions of the spline.

The method can include receiving, by the data processing system, via the graphical user interface from the client device, a first definition of a first set of parameters for a first feature. The method can include receiving, by the data processing system, via the graphical user interface from the client device, a second definition of a second set of parameters for a second feature. The method can include generating, by the data processing system, a first re-binned indicator table based on a first indicator table generated by machine learning for the first feature and the first set of parameters. The method can include generating, by the data processing system, a second re-binned indicator table based on a second indicator table generated by machine learning for the second feature and the second set of parameters.

The method can include generating, by the data processing system, data to cause the graphical user interface to include an element to select between an automatic generation of the second table and a manual generation of the second table.

The method can include fitting, by the data processing system, the spline to the table based on the cost function weighted based on the number of entries of the feature for the ranges of values of the feature responsive to a selection of the automatic generation by the client device via the graphical user interface.

At least one aspect is directed to one or more computer readable media storing instructions. The instructions can cause the one or more processors to identify a table generated by a model trained with machine learning, the table including bins for ranges of values of a feature and coefficients that indicate a level of a target for the bins. The instructions can cause the one or more processors to receive, via a graphical user interface from a client device, a request to modify bins of the table. The instructions can cause the one or more processors to establish, responsive to the request, a spline to fit the table based at least in part on a cost function weighted based on a number of entries of the feature for the ranges of values of the feature. The instructions can cause the one or more processors to generate, via the spline established based at least in part on the cost function, a second table including second bins and second coefficients. The instructions can cause the one or more processors generate data to cause the graphical user interface to include a graphic representation of the second table.

The instructions can cause the one or more processors to generate a first bin for a first range of values of the feature of the second bins in a first resolution proportional to a first slope of the spline over the first range of values of the feature. The instructions can cause the one or more processors to generate a second bin for a second range of values of the feature of the second bins in a second resolution proportional to a second slope of the spline over the second range of values of the feature.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a block diagram of a data processing system that performs re-binning and smoothing of an indicator table to generate a re-binned indicator table, in accordance with present examples.

FIG. 2 is a diagram of re-binned tables generated by an automatic re-binning process and a manual re-binning process, in accordance with present examples.

FIG. 3 is a chart of points of a piece-wise function fit to an indicator table, in accordance with present examples.

FIG. 4 is a chart of a piece-wise function fit to an indicator table, in accordance with present examples.

FIG. 5 is a graphical user interface including an indicator table for a feature, in accordance with present examples.

FIGS. 6-7 are graphical user interfaces including an element for creating a parameter set and elements representing existing parameter sets, in accordance with present examples.

FIG. 8 is a graphical user interface including elements for performing an automatic re-binning process, in accordance with present examples.

FIG. 9 is a graphical user interface including elements for performing a manual re-binning process, in accordance with present examples.

FIG. 10 is a graphical user interface including elements for performing a manual re-binning process where a formatting error is detected in user entered data, in accordance with present examples.

FIG. 11 is a method of re-binning and smoothing an indicator table to generate a re-binned indicator table, in accordance with present examples.

FIG. 12 is an example of the data processing system of FIG. 1, in accordance with present examples.

FIGS. 13-18 depict display screens or portions thereof with graphical user interfaces, in accordance with present examples.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

This disclosure is generally directed to re-binning and smoothing an indicator table. An indicator table can be generated by a model or models trained by machine learning. For example, the indicator table can be generated by a generalized additive model (GAM). The GAM can utilize a decision tree to generate bins. The bins can be a range of values for a feature. For example, a feature can be an age of a person. The bins generated by the decision tree can include ages 10-30, ages 30-40, and ages 40-60. The GAM can include a generalized linear model (GLM) that generates coefficients for the bins. The coefficients can indicate levels for each bin. For example, the GLM can generate one coefficient for each bin. The coefficients and bins can form an indicator table. The indicator table can be or include a tabular formatting of the bins and coefficients. A performance of a system that consumes the indicator table can be limited to the resolution of the indicator table. Furthermore, large jumps in coefficient value between bins can be undesirable. Increasing the resolution of the bins, e.g., generating more bins with smaller ranges of values, can have technical challenges.

To make the ranges of the bins narrower and increase the resolution of the indicator table, minimum observations in leaf nodes in the decision tree can be lowered. However, this increase the variance of the coefficients, for example, this can make the indicator table less accurate. Accordingly, a trade-off can exist between how large the decision tree is and how accurate the coefficients of the indicator table are. To increase the accuracy of the indicator table, the decision tree can be kept small but this ends up resulting in bins with wide ranges. However, increasing the size of the decision tree, while reducing the size of the bins, can result in less accurate coefficients for the bins.

To solve these and other technical problems, the system described herein can generate an indicator table through a re-binning process. The system can perform post-processing on an indicator table generated by the GAM to re-bin and smooth the indicator table. The post-processing can perform re-binning and smoothing by generating new bins and coefficients by fitting a spline to the indicator table generated by the GAM. The spline can be a piece-wise function, e.g., a collection of polynomial functions where each polynomial function exists over a particular range of the indicator table. The functions of the piece-wise function can include at least one function type or a combination of function types. The function types can include constants, linear functions, quadratic functions, cubic functions, or any other type of function. The functions can begin or end at various knots. The knots can define the points across which a function of the split exists. The knots can define the points where ends of the spline pieces meet (e.g., the points where the ends of the functions of the piece-wise function meet).

The system can run a computer process on an objective function to fit a spline to the bins and coefficients of the indicator table. The objective function can minimize a summation of distances between points representing the bins and the spline. The spline can be split into new bins and new coefficients. For example, a level of the spline over each new bin range can be used to determine the new coefficients. The resulting new coefficients and bins can form a re-binned indicator table. By performing the re-binning process, a smoothed and increased resolution indicator bin can be formed without increasing the size of the decision tree and sacrificing accuracy for increased smoothness or increased resolution. By improving the indicator table without increasing the size of the decision tree, a smaller decision tree can be stored and processed. This can reduce memory usage by the decision tree and reduce the consumption of processing resources that execute the decision tree.

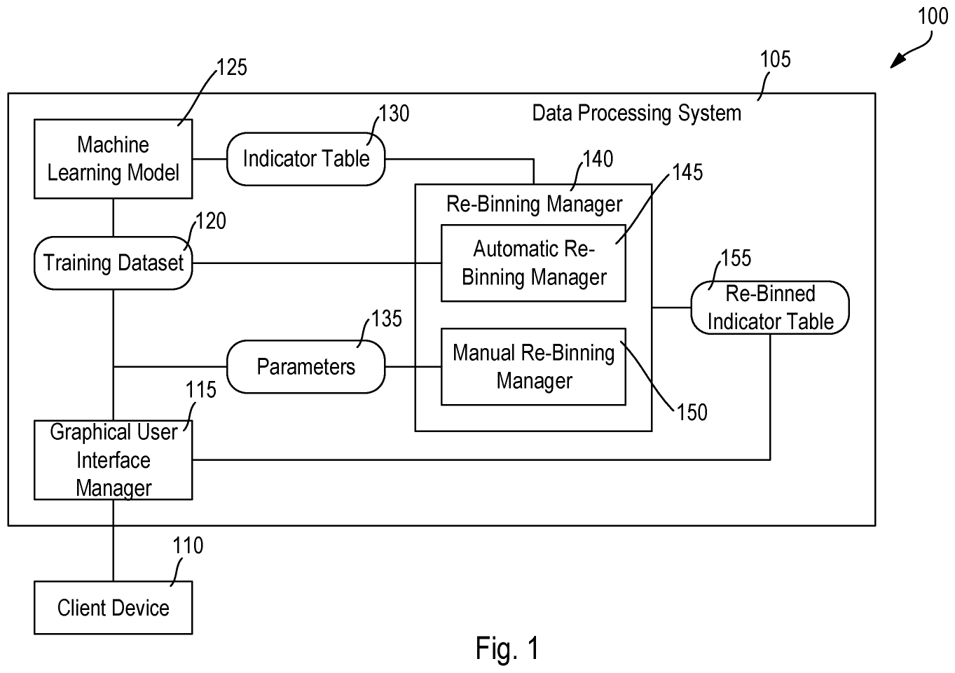

FIG. 1 is a block diagram of an example system 100 including a data processing system 105 that performs re-binning and smoothing of at least one indicator table 130 to generate at least one re-binned indicator table 155, in accordance with present examples. The data processing system 105 can be a server system, a cloud computing platform, a local computing system, a laptop computer, a desktop computer. The data processing system 105 can receive at least one training dataset 120 from a client device 110. The client device 110 can be a computing system separate from the data processing system 105. The client device 110 can be integrated with the data processing system 105. For example, the data processing system 105 can be a component of the client device 110 or the client device 110 can be a component of the data processing system 105.

The client device 110 can be a server system, a cloud computing platform, a local computing system, a laptop computer, a desktop computer. The client device 110 can be a device of a user, for example, a machine learning engineer, a data scientist, a business manager, or any other user. The user can provide the training dataset 120 to the data processing system 105 through the client device 110. For example, the user can upload the training dataset 120 to the data processing system 105 via the client device 110. The training dataset 120 can be uploaded via at least one network. The network can include a local area network (LAN), a wide area network (WAN), a metropolitan area network (MAN). The network can include the Internet. The network can include a Wi-Fi network. The network can include a cellular network (e.g., 3G, 4G, 5G, 6G).

The client device 110 can provide the training dataset 120 in a file of a particular file format. The file can be a comma separated value (CVS) file, a tab separated value (TSV) file, a data source view (DSV) file, an EXCEL spreadsheet (XLS) file, an EXCEL Open Extensible Markup Language (XML) Spreadsheet (XLSX) file, a Statistical Analysis System 7BDAT (SAS7BDAT) file, a geographic JavaScript Object Notation (GEOJSON) file, a GNU zipped (GZ) file, a BZ1 file, a tape achieve file (TAR) file, a TGZ file, or a zipped (ZIP) file. The client device 110 can provide a training dataset 120 that includes a variety of features. The features can be individual measurable properties that a machine learning model can train on or generate inferences on. The features can include categorical features, numerical features, text features, location features, Boolean features, or any other type of feature.

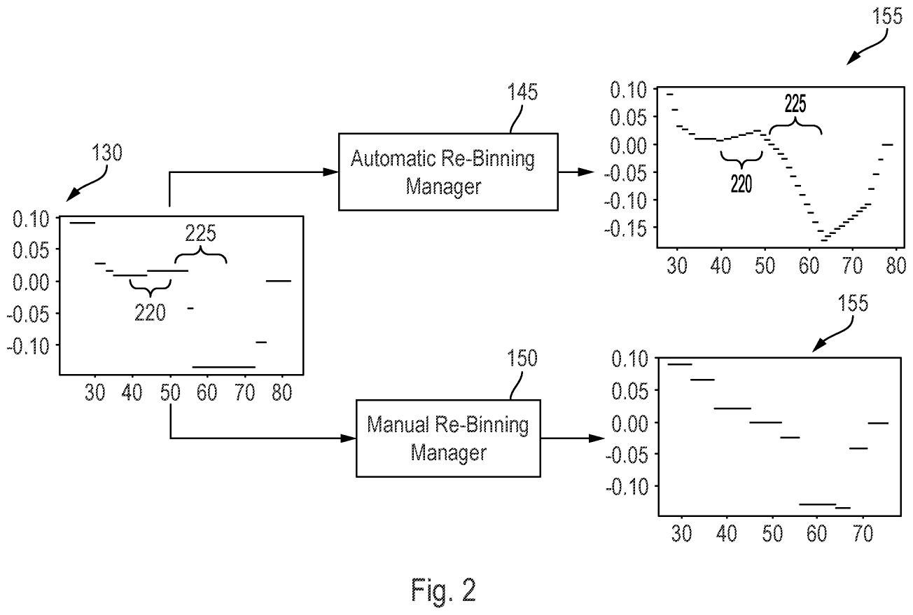

The client device 110 can display at least one graphical user interface to the user. The graphical user interfaces can be, for example, the graphical user interfaces and graphical user interface elements of FIGS. 2 and 5-10. The client device 110 can display the graphical user interfaces based on data received from at least one graphical user interface manager 115 of the data processing system 105. For example, the graphical user interface manager 115 can generate data that causes the client device 110 to display a graphical user interface. The graphical user interface manager 115 can receive interactions, selections, button presses, slider adjustments, or other inputs to the graphical user interface on the client device 110.

The data processing system 105 can generate or store at least one machine learning model 125. The machine learning model 125 can be a model trained via a machine learning algorithm on training data. The training data can be the training dataset 120 or another training dataset. The machine learning model 125 can process the training dataset 120 to generate an indicator table 130. The training dataset 120 can include at least one feature and at least one target. The training dataset 120 can include pairs of features and targets. The client device 110 can provide data to the data processing system 105 identifying feature and target pairs. The machine learning models 125 can generate an indicator table 130 for each feature and target pair. The machine learning models 125 can include a GAM including a decision tree and a GLM. The decision tree can generate ranges for bins and numbers of bins for a feature. The GLM can generate coefficients for each bin indicating a level of the target for the range of values of a feature in the bin. The data processing system 105 can generate an indicator table 130 based on the bins and coefficients generated by the machine learning model 125.

The graphical user interface manager 115 can generate data to cause at least one indicator table 130 to be displayed in a graphical user interface on the client device 110. A user, via the client device 110, can generate a request to re-bin at least indicator table 130. The request can cause the data processing system 105 to generate a re-binned indicator table 155 based on the indicator table 130. The data processing system 105 can include a re-binning manager 140. The re-binning manager 140 can generate the re-binned indicator table 155 based on the indicator table 130. The re-binning manager 140 can generate the re-binned indicator table 155 based on the training dataset 120 or the parameters 135.

The re-binning manager 140 can include at least one automatic re-binning manager 145. The re-binning manager 140 can include at least one manual re-binning manager 150. The re-binning manager 140 can receive a request from the client device 110 to automatically re-bin the indicator table 130. Responsive to receiving the request to automatically re-bin the indicator table 130, the automatic re-binning manager 145 can be executed to generate the re-binned indicator table 155. The re-binning manager 140 can receive a request from the client device 110 to manually re-bin the indicator table 130. Responsive to receiving the request to manually re-bin the indicator table 130, the manual re-binning manager 150 can be executed to generate the re-binned indicator table 155. The re-binning manager 140 can fit a piece-wise function to the indicator table 130. The re-binning manager 140 can generate the re-binned indicator table 155 from the piece-wise function.

The automatic re-binning manager 145 can execute a computer process to generate the re-binned indicator table 155 based on the indicator table 130 and the training dataset 120. The automatic re-binning manager 145 can generate the re-binned indicator table 155 without requiring any, or without requiring more than a particular amount, of user configuration data, e.g., the parameters 135. The automatic re-binning manager 145 can fit a piece-wise function to the indicator table 130. For example, the automatic re-binning manager 145 can use an objective function, such as a cost function, to fit the piece-wise function to the indicator table 130. The objective function can include a summation of distances between the bins and coefficients of the indicator table 130 and a line formed by functions of the piece-wise function. The objective function can sum a distance between a line of the piece-wise function and each bin of the indicator table 130. The automatic re-binning manager 145 can execute a computer process to determine a piece-wise function that minimizes the objective function. The computer process can include one or a combination of a Fibonacci search, a Golden Section Search, a Bisection Method), a gradient descent, nonlinear least squares, Newton's method, Secant method, Quasi-Newton method. The objective function can be weighted based on a number of feature entries in each bin. The automatic re-binning manager 145 can fit the piece-wise function to the indicator table based on the objective function weighted based on the number of entries of the feature for the ranges of values of the feature responsive. For example, for an age feature, there may be six individuals associated with a bin of age ranges from 20-30. For another bin range of ages 30-40, there may be twenty individuals. The bin for the range of ages 30-40 can be weighted more than the bin of age ranges from 20-30. Weighting the objective function can cause the piece-wise function to be weighted more strongly towards bins where more data is present and the coefficient of the bin is more reliable. This can improve the accuracy of the piece-wise function.

The automatic re-binning manager 145 can, based on the objective function, select different function types for the functions of the piece-wise function. The piece-wise function can include a single type of function, two different types of functions, three different types of functions, or a variety of different types of functions. For example, the different types of functions can be constants, linear functions, quadratic functions, or cubic functions. At least one first function of the piece-wise function can be a first function type while at least one second function of a second function type. The first function type can be linear while the second function type can be constant.

The automatic re-binning manager 145 can generate the re-binned indicator table 155 from the piece-wise function. The automatic re-binning manager 145 can generate bins and coefficients based on the piece-wise function. For example, the automatic re-binning manager 145 can generate the bins and coefficients based on the line of the piece-wise function. The automatic re-binning manager 145 can generate the bins for the re-binned indicator table 155 based on a slope or gradient of the piece-wise function. For example, the automatic re-binning manager 145 can generate higher resolution bins for sections of the piece-wise function with a steep slope or high gradient, e.g., a slope or gradient above a threshold. The automatic re-binning manager 145 can generate lower resolution bins for sections of the piece-wise function with a low slope or low gradient, e.g., a slope or gradient less than a threshold. Higher resolution bins can be bins of small ranges of the feature while lower resolution bins can be bins of greater ranges of the feature. By generating higher resolution bins in areas of the piece-wise function where the slope or gradient is steep, the resulting re-binned indicator table 155 can have less jumps between target levels. For example, the automatic re-binning manager can generate a first bin for a first range of values of the feature in a first resolution proportional to a first slope of the piece-wise function over the first range of values of the feature. The re-binning manager can generate a second bin for a second range of values of the feature in a second resolution proportional to a second slope of the piece-wise function over the second range of values of the feature. Each bin of generated by the automatic re-binning manager 145 can have a different resolution which can be based on, or proportional to, the slope of the piece-wise function.

The automatic re-binning manager 145 can generate a coefficient based on the piece-wise function for each bin identified by the automatic re-binning manager 145. The automatic re-binning manager 145 can generate a coefficient for each bin to be a maximum value of the piece-wise function for the target across the range of the bin, a minimum value of the piece-wise function for the target across the range of the bin, or an average value of the piece-wise function for the target across the range of the bin.

The manual re-binning manager 150 can generate the re-binned indicator table 155 based on at least one parameter 135. A user can provide the parameters 135 via a graphical user interface generated or managed by the graphical user interface manager 115. For example, the manual re-binning manager 150 can receive parameters 135 defining a piece-wise function and the manual re-binning manager 150 can generate the piece-wise function based on the parameters 135. Furthermore, the parameters 135 can include a plurality of ranges for functions of the piece-wise function and function types for the plurality of ranges. For example, the user input can define parameters 135 such as the knots for spline pieces of a spine and the type of spline piece for each spline piece, e.g., constant, linear, etc. Furthermore, the parameters 135 can indicate a feature transformation to apply values of the feature of the indicator table 130 before the re-binning and smoothing is performed by the manual re-binning manager 150. The transformations can be a square root, a logarithm, a logarithm of a value of the feature plus an offset. Furthermore, the parameters 135 can identify the edges for new bins. For example, the edges can define ranges of the feature for each bin of a set of bins. Based on the parameters 135, the manual re-binning manager 150 can transform the feature, generate a spline based on the knots and spline types provided by the parameters 135, and generate new bins and coefficients for the bins based on the spline and the re-binning edges provided by the parameters 135.

A user can provide different sets of parameters 135 to the manual re-binning manager 150 via the client device 110 for different features and indicator tables 130. For example, the graphical user interface manager 115 can receive a first definition of a first set of parameters 135 for a first feature associated with a first indicator table 130. Based on the first indicator table 130 and the first set of parameters 135, the manual re-binning manager 150 can generate a first re-binned indicator table 155. Furthermore, the graphical user interface manager 115 can receive a second definition of a second set of parameters 135 for a second feature associated with a second indicator table 130. Based on the second indicator table 130 and the second set of parameters 135, the manual re-binning manager 150 can generate a second re-binned indicator table 155.

The graphical user interface manager 115 can analyze the input format of the parameters 135 provided by the client device 110. The graphical user interface manager 115 can detect whether a formatting issue has occurred in the input provided by client device 110. The graphical user interface manager 115 can store a set of rules that define a language. The language can define how the parameters 135 should be formatted with colons, commas, parenthesis, brackets, order of data, etc. The set of rules can define a format that the graphical user interface manager 115 expects to receive the parameters 135 in. The graphical user interface manager 115 can compare a first format that the user used to format the parameters 135 to a second format defined by the set of rules. Responsive to detecting that the first format does not match the second format, the graphical user interface manager 115 can generate data causing a graphical user interface displayed on the client device 110 to display an alert responsive to a determination of a difference between the first format and the second format.

The data processing system 105 can provide the re-binned indicator table 155 to the graphical user interface manager 115. The graphical user interface manager 115 can generate data that causes a graphical user interface displayed on the client device 110 to include a graphical representation of the re-binned indicator table 155. The graphical user interface manager 115 can transition a display of the indicator table 130 from displaying the indicator table 130 to displaying the re-binned indicator table 155. For example, the graphical user interface manager 115 can animate a transition within a graph displaying bins and coefficients of the indicator table 130 to displaying bins and coefficients of the re-binned indicator table 155.

The data processing system 105 can perform an action based on the re-binned indicator table 155. For example, the data processing system 105 can retrieve a coefficient value for a bin range or identify a bin range of the re-binned indicator table 155, and use the retrieved information to perform the action. The action can include navigating or controlling a vehicle or motors, engines, steering apparatus, or braking apparatus of the vehicle, e.g., causing the vehicle to drive forward, drive in reverse, turn, stop, avoid an obstacle, make a route decision, etc. The action can be detecting an object from sensor data (e.g., image data, radar data, etc.). The detected object can be used to operate the vehicle. The action can include a supply chain action, e.g., ordering a part, ordering a product, or ordering a piece of equipment, cancelling an order, directing the order, diverting an order, etc. Because the re-binned indicator table 155 is re-binned and smoothed compared to the indicator table 130, the actions taken by the data processing system 105 can have increased accuracy or performance, thereby improving vehicle navigation, object detection, or supply chain ordering. Actions performed on the re-binned indicator table 155 can have significant accuracy or precision improvements compared to actions performed on the indicator table 130.

FIG. 2 is an example diagram of re-binned indicator tables 155 generated by the automatic re-binning manager 145 and the manual re-binning manager 150. The indicator table 130 can be received by either or both of the automatic re-binning manager 145 and the manual re-binning manager 150. The automatic re-binning manager 145 can generate a first re-binned indicator table 155. The manual re-binning manager 150 can generate a second re-binned indicator table 155. The manual re-binning manager 150 can generate the re-binned indicator table 155 from the indicator table 130 based on the parameters 135.

The automatic re-binning manager 145 can generate the re-binned indicator table 155 from the indicator table 130 by fitting a piece-wise function to the bins and coefficients of the indicator table 130. The automatic re-binning manager 145 can determine ranges of values of the feature for the bins of the re-binned indicator table 155 by analyzing a slope or gradient of the piece-wise function. For example, for a first range 220 of values of the feature, the piece-wise function may have a first slope which is low, e.g., lower than a second slope of a second range 225 of values of the feature. The automatic re-binning manager 145 can generate bins of a first resolution, e.g., a first resolution of wide bins wider than a second resolution of narrower bins. For the second range 225, the automatic re-binning manager 145 can generate bins of a higher resolution, e.g., narrower bins than the bins in the range 220.

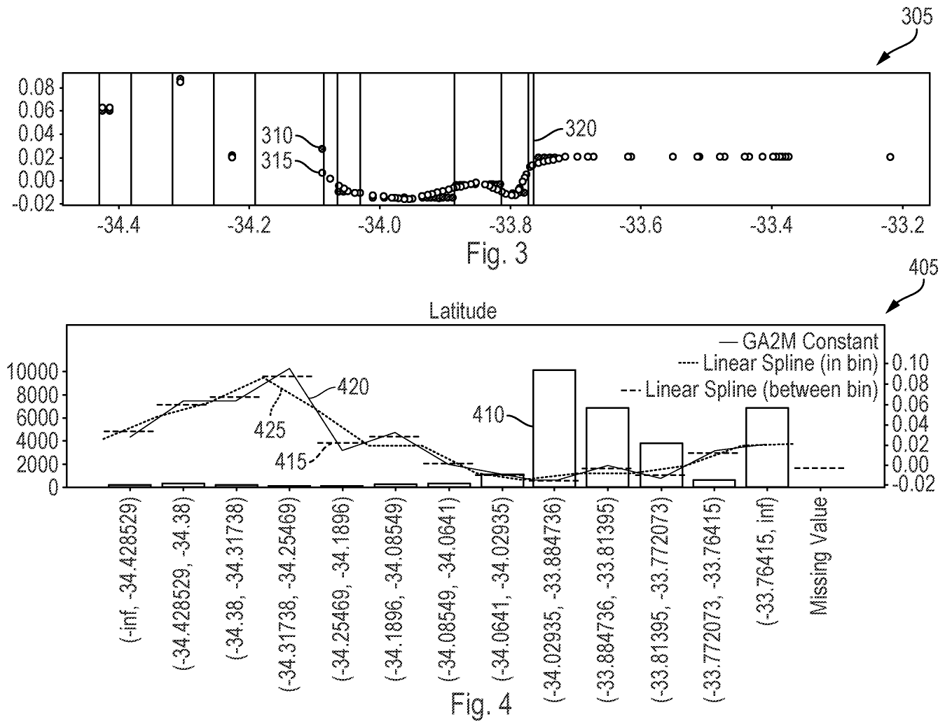

FIG. 3 is an example chart 305 of points of a piece-wise function fit to the indicator table 130, in accordance with present examples. The chart 305 can include dots 310. The dots 310 can represent the coefficients or bins of the indicator table 130. The vertical lines 320 can represent the bins the of indicator table 130. The dots 315 can represent the piece-wise function fit to the dots 310. The automatic re-binning manager 145 can determine a distance between each dot 310 and each dot 315. For example, the automatic re-binning manager 145 can determine a distance between pairs of dots 310 and 315. The automatic re-binning manager 145 can implement an objective function that sums all of the distances together. The automatic re-binning manager 145 can run a computer process that identifies a piece-wise function that minimizes a summation of the distances represented in the objective function.

FIG. 4 is an example chart 405 of a piece-wise function fit to the indicator table 130, in accordance with present examples. The chart 405 can represent the indicator table 130, e.g., bins and coefficients of the indicator table 130, with lines 415. The chart 405 includes bars 410. The bars 410 can represent an amount of data points or data entries of a feature of the indicator table 130 in various ranges. The automatic re-binning manager 145 can weigh the objective function based on the number of data points or data entries of the feature in each range of values of the feature. The automatic re-binning manager 145 can assign a higher weight to the piece-wise function in the ranges of features with higher numbers of data entries and assign a lower weight to the piece-wise function in the ranges of features with lower numbers of data entries. The line 420 can represent a piece-wise function between bins while the line 425 can represent a piece-wise function in bins.

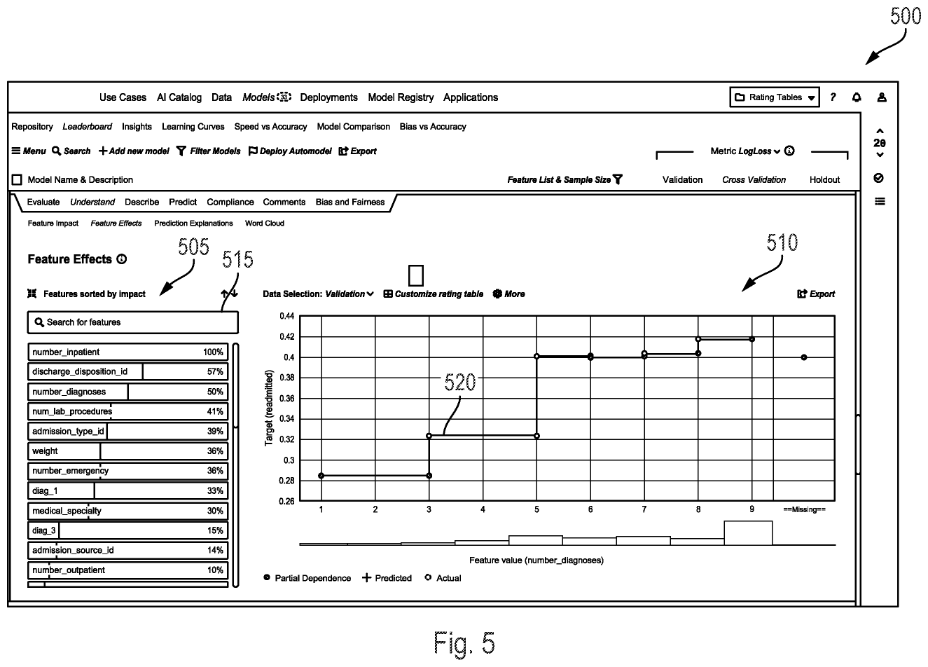

FIG. 5 is an example graphical user interface 500 including a graphical representation 510 of the indicator table 130 for a feature, in accordance with present examples. The graphical user interface 500 includes a list 505. The list 505 includes indications of features of the training dataset 120 that the data processing system 105 generated an indicator table 130 for. The data processing system 105 can generate a score for each feature. The score can indicate the influence that the feature has on predicting a target. The list of features can be ranked in descending order of score, with the highest scores listed on the top and the lowest scores listed on the bottom. The list 505 can include at least one search element 515. A user can enter letters, numbers, words, phrases, acronyms, into the search element 515 and the list 505 can be filtered based on the user input.

The graphical user interface 500 can include at least one indicator table 130. The graphical user interface 500 can receive a selection of at least one feature from the feature list 505. The data processing system 105 can identify an indicator table 130 corresponding to each selected feature. The graphical user interface manager 115 can cause the graphical user interface 500 to display at least one indicator table 130 in the graphic representation 510 corresponding to the selected features. The graphic representation 510 can include a chart to represent the indicator table 130. The chart can include a y-axis representing the target. The chart can include an x-axis representing values of the feature. A line 520 can represent the bins and coefficients of the indicator table 130. The flat portions of the line 520 can represent each individual bin. The level assigned to each horizontal portion can represent the coefficients of each bin.

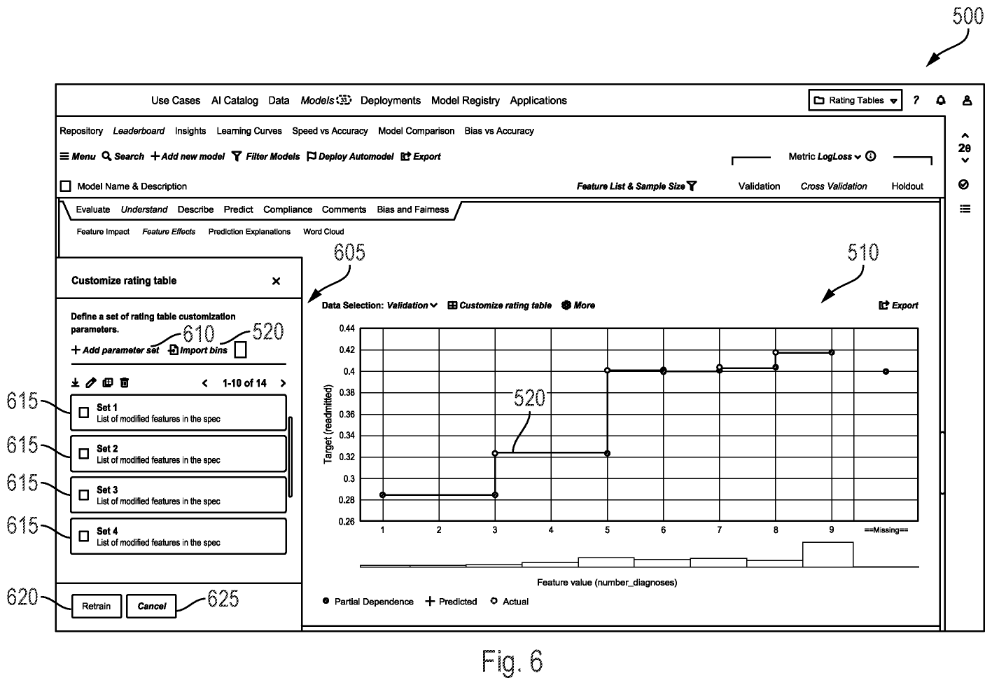

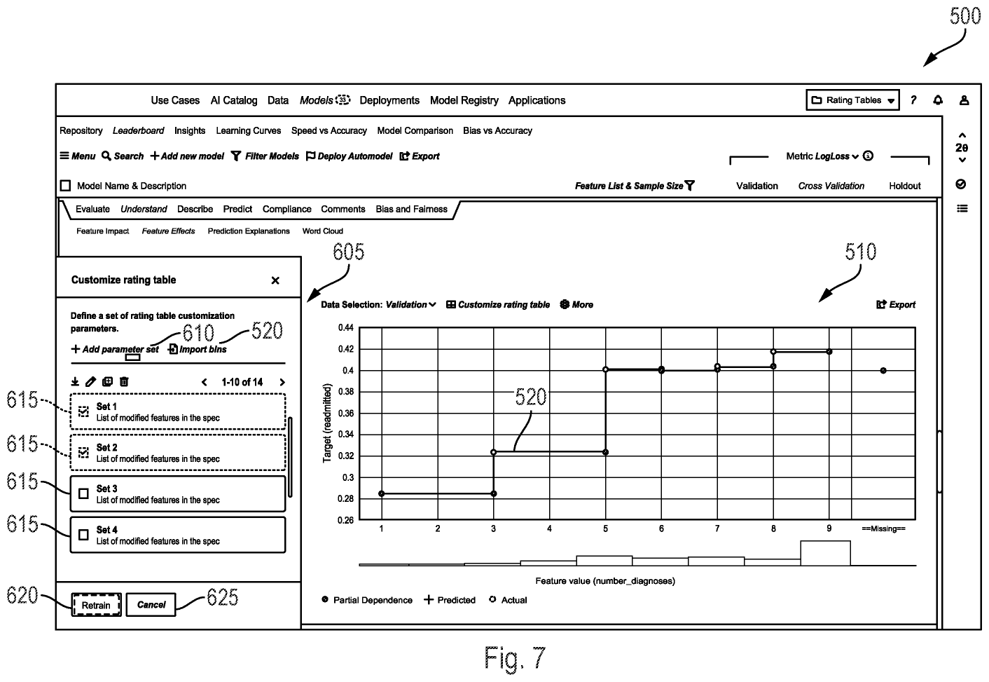

FIGS. 6-7 are the example graphical user interface 500 including at least one element 605 for creating a parameter set and elements 615 representing existing parameter sets, in accordance with present examples. The element 605 can include an element 610. The element 610 can allow a user to add new parameter sets to a project. The element 605 can include elements 615 representing existing parameter sets. The parameter sets can define a collection of one or multiple features or indicator tables 130 for one or multiple features. The parameter sets can define bins and coefficients for one or multiple features. The parameter sets can further define parameters to be used in re-binning and smoothing the indicator tables 130 associated with the sets. For example, the parameters can indicate whether the re-binning manager 140 should perform automatic re-binning via the automatic re-binning manager 145 or manual re-binning via the manual re-binning manager 150. For automatic re-binning, the parameters can indicate a maximum number of bins for use in automatic re-binning of the indicator tables 130. For the manual re-binning, the parameters can include the parameters 135. For example, the parameters can indicate knots and spline types of a piece-wise function, a feature transformation, edges for new bins. The element 605 can include an element 520. Responsive to interacting with the element 520, an element or graphical user interface can be displayed on the client device 110 for importing bins.

The graphical user interface 500 can include an element 620 to retrain the indicator table 130, e.g., apply re-binning and smoothing to the indicator table 130. The element 620 can be deactivated by the graphical user interface manager 115 responsive to the graphical user interface manager 115 detecting that none of the sets have been selected, e.g., as shown in FIG. 6. Responsive to detecting that at least one of the sets have been selected, the graphical user interface manager 115 can activate the element 620, e.g., as shown in FIG. 7. Responsive to a user interacting with the element 620 via the client device 110, the re-binning manager 140 can execute the automatic re-binning manager 145 or the manual re-binning manager 150 to generate the re-binned indicator table 155 from the indicator table 130. Responsive to a user interacting with the element 625, the element 605 can be closed or removed from the graphical user interface 500 by the graphical user interface manager 115.

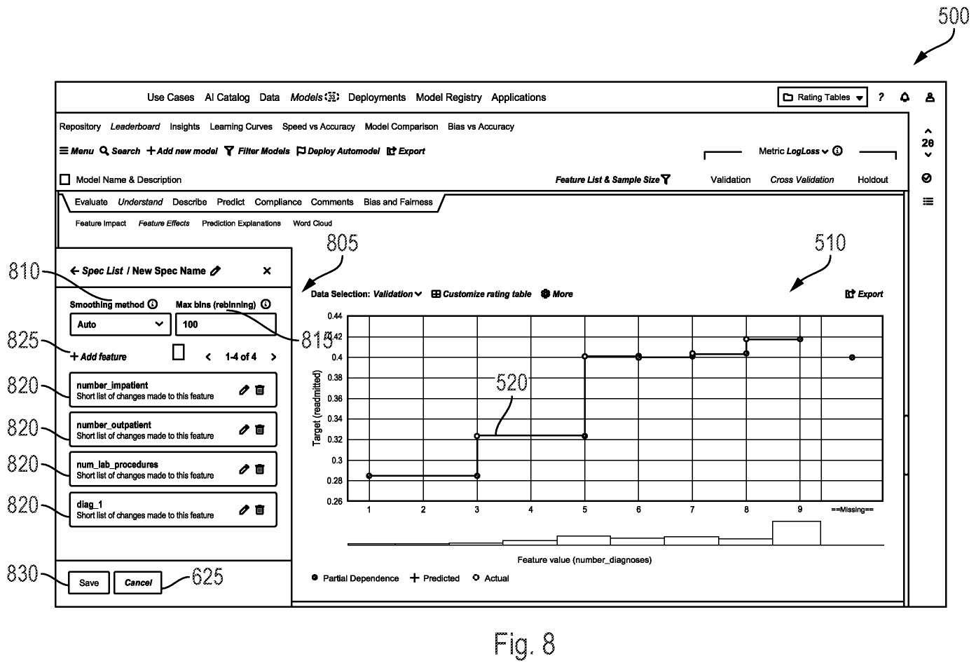

FIG. 8 is the example graphical user interface 500 including elements for performing an automatic re-binning process, in accordance with present examples. Responsive to a user interacting with the element 610 to add a new parameter set, the graphical user interface 500 can display the element 805 for constructing the new parameter set. In the graphical user interface 500, a user can select between automatic re-binning and smoothing and manual re-binning and smoothing via an element 810 of the element 805. Furthermore, responsive to a user interacting with an add feature element 825, one or more elements or graphical user interface can be displayed allowing a user, via the client device 110 to select at least one feature 820 of the training dataset 120.

The element 805 can include a max bins element 815. A user can enter the maximum number of bins that the automatic re-binning manager 145 should cause the re-binned indicator table 155 to include. For example, the automatic re-binning manager 145 can fit a piece-wise function to the indicator table 130 and then generate the bins and coefficients for the re-binned indicator table 155 based on the piece-wise function and the maximum number of bins. The automatic re-binning manager 145 can generate the re-binned indicator table 155 to include a number of bins equal to or less than the maximum number of bins. Responsive to the user interacting with a save element 830, the new parameter set can be saved. Responsive to the user interacting with the save element 830, the automatic re-binning manager 145 can generate the re-binned indicator table 155 from the indicator table 130. An element 615 can be added to the element 605 by the graphical user interface manager 115. Responsive to a user selecting the element 615 representing the new parameter set and the user interacting with the element 620, the indicator table 130 can be generated by the machine learning model 125 and the re-binned indicator table 155 can be generated from indicator table 130 by the automatic re-binning manager 145.

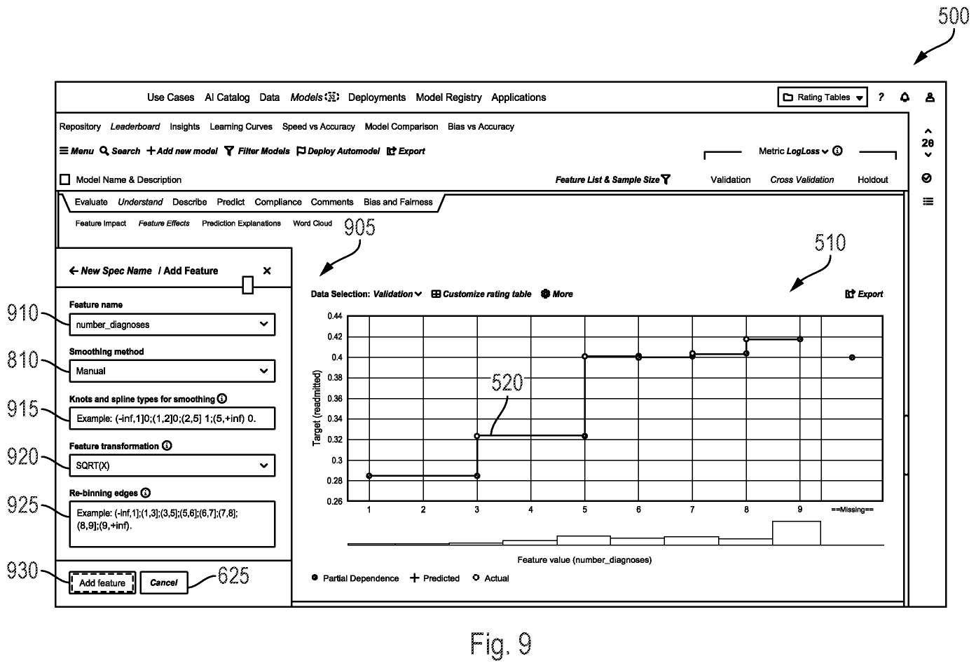

FIG. 9 is the example graphical user interface 500 including elements for performing a manual re-binning process, in accordance with present examples. The graphical user interface 500 can include at least one element 905 for defining the parameters 135 for the manual re-binning manager 150 to use to generate the re-binned indicator table 155 from the indicator table 130. The graphical user interface manager 115 can generate data that causes the client device 110 to display the element 905 responsive to a user selecting manual via the element 810. The element 905 can include a feature selector element 910. A user can select a name of a feature of the training dataset 120 to perform manual re-binning and smoothing on by interacting with the feature selector element 910 via the client device 110.

The element 905 can include an element 915 for defining knots and spline types for a spline. The user can define, via the element 905, knots, e.g., points where the functions can begin or end. The knots can define the points across which a function of the split exists. The knots can define the points where ends of the spline pieces meet (e.g., the points where the ends of the functions of the piece-wise function). For example, the user could enter “(−inf, 1]” to represent a first function that extends from negative infinity to one. The user could enter “(1, 2]” to represent a second function that extends from one to two. Furthermore, for each function of the piece-wise function (e.g., each spline piece of a spline) a user can enter a function type or spline piece type, e.g., via the element 915. The function types can include constants, linear functions, quadratic functions, cubic functions, or any other type of function. A user can indicate the function type for each spline piece or function with a numeric indicator, e.g., “0” to represent a constant, “1” to represent linear, etc. The spline piece or function type can be entered with the knots. For example, “(1, 2] 0;” can indicate a constant spline piece or function type between one and two.

The element 905 can include an element 925 for defining the edges of bins for the re-binned indicator table 155. The edge of the bins can be defined as ranges, e.g., for a first bin, the range can be negative infinity to one, e.g., “(−inf, 1].” A second bin can be defined between one and three, e.g., “(1, 3].” The manual re-binning manager 150 can generate a coefficient for each bin. The automatic re-binning manager 145 can generate a coefficient for each bin defined in the element 925 to be a maximum value of the piece-wise function defined by the element 915 for the target across the range of the bin, a minimum value of the piece-wise function defined by the element 915 for the target across the range of the bin, or an average value of the piece-wise function defined by the element 915 for the target across the range of the bin. An element 920 can be a selectable element for defining a feature transformation type. Responsive to a user completing entry of data into the element 905, the user can interact with an add feature element 930 to complete the configuration of the indicator table 155.

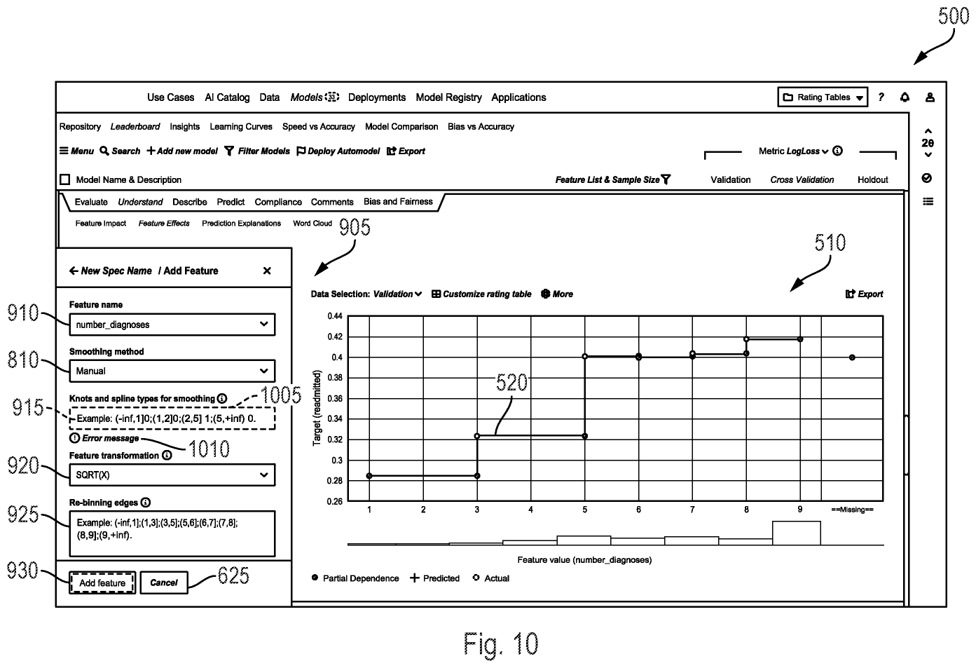

FIG. 10 is the example graphical user interface 500 including elements for performing a manual re-binning process where a formatting error is detected in user entered data, in accordance with present examples. The graphical user interface manager 115 can compare the input format of user input into the elements 915 and 925 against a second or standard format. The standard format can indicate at least one rule for the composition of parenthesis, brackets, semicolons periods, numbers, letters, words, etc. in defining the knots and spline types or the re-binning edges. The graphical user interface manager 115 can compare the input format against the standard format. Responsive to detecting that the entered format matches the standard format, the graphical user interface manager 115 can generate data indicating the match. Responsive to detecting that the entered format does not match the standard format, the graphical user interface manager 115 can generate data indicating the mismatch. The graphical user interface manager 115 can cause the user interface 500 to include a box 1005. The box 1005 can surround the line 520. The box 1005 can be colored, e.g., red. The box 1005 can indicate that the format of the data entered into the element 915 does not match the standard format. The graphical user interface manager 115 can cause the user interface 500 to display an error message 1010 indicating that the format of data entered into the element 915 does not match the standard format.

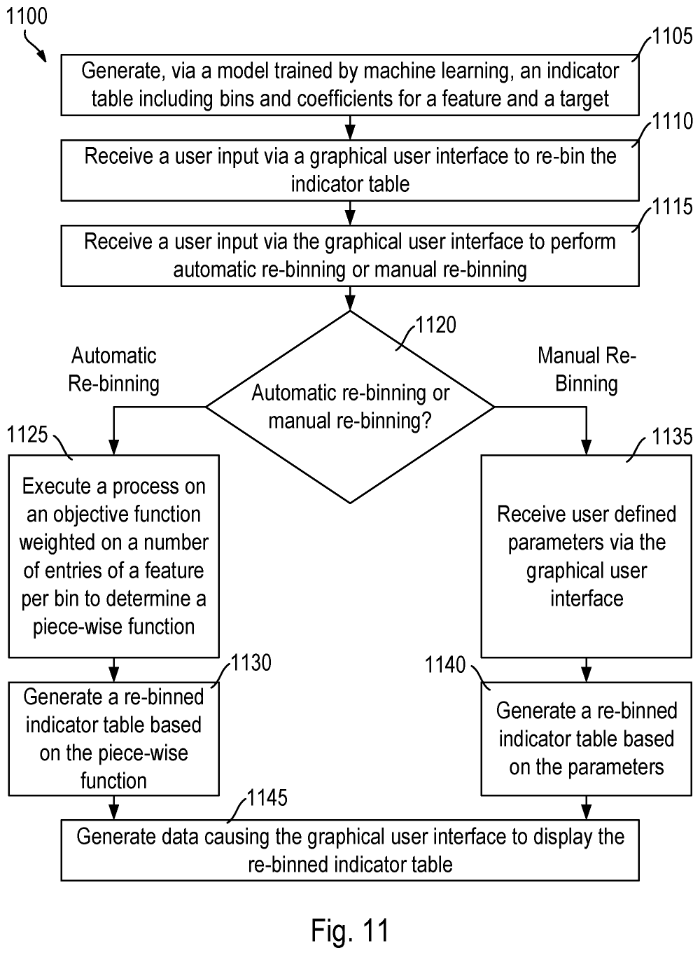

FIG. 11 is an example method 1100 of re-binning and smoothing an indicator table 130 to generate a re-binned indicator table 155, in accordance with present examples. The data processing system 105 can perform at least one ACT of the method 1100. The client device 110 can perform at least one ACT of the method 1100. Furthermore, any cloud-computing system, desktop computer, laptop computer, server system, distributed processing system, Internet of Things (IoT) device can perform at least one ACT of the method 1100.

The method 1100 can include an ACT 1105 of generating, via a model trained by machine learning, an indicator table including bins and coefficients for a feature and a target. The method 1100 can include an ACT 1110 of receiving a user input via a graphical user interface to re-bin the indicator table. The method 1100 can include an ACT 1115 of receiving a user input via the graphical user interface to perform automatic re-binning or manual re-binning. The method 1100 can include an ACT 1120 of determining whether automatic re-binning or manual re-binning has been selected. The method 1100 can include an ACT 1125 of executing a process on an objective function weighted on a number of entries of a feature per bin to determine a piece-wise function. The method 1100 can include an ACT 1130 of generating a re-binned indicator table based on the piece-wise function. The method 1100 can include an ACT 1135 of receiving user defined parameters via the graphical user interface. The method 1100 can include an ACT 1140 of generating a re-binned indicator table based on the parameters. The method 1100 can include an ACT 1145 of generating data causing the graphical user interface to display the re-binned indicator table.

The method 1100 can include an ACT 1105 of generating, by the data processing system 105 via machine learning model 125, an indicator table 130 including bins and coefficients for a feature and a target. Generating the indicator table 130 can include training the machine learning model 125 based on the training dataset 120. Generating the indicator table 130 can include executing the machine learning model 125 based on the training dataset 120 to generate the indicator table 130. Generating the indicator table 130 can include generating bins for ranges of a feature and coefficients that indicate a level of a target for each bin. Each bin can be associated with one coefficient. The machine learning model 125 can be or include a GAM. The GAM can include at least one decision tree and a GLM. Generating the indicator table 130 can include executing the decision tree to generate the bins and execute the GLM to generate the coefficients for each bin.

The method 1100 can include an ACT 1110 of receiving, by the data processing system 105, a user input via the graphical user interface 500 to re-bin the indicator table 130. Receiving the user input can include receiving a selection of a feature or multiple features from a set of features. The data processing system 105 can select the indicator table 130 associated with the feature selected by the user. The graphical user interface 500 can include the element 610 to create a new parameter set for a feature. The graphical user interface 500 can include elements 615 representing parameters sets for features previously created. A user can create a new parameter set defining a configuration to re-bin an indicator table 130. The user can select an existing parameter set defining a configuration to re-bin an indicator table 130.

The method 1100 can include an ACT 1115 of receiving, by the data processing system 105, a user input via the graphical user interface 500 to perform automatic re-binning or manual re-binning. The graphical user interface 500 can include an element 810. The element 810 can allow a user to select, via the client device 110, between performing automatic re-binning and manual re-binning. The element 810 can select between executing the automatic re-binning manager 145 to perform the automatic re-binning process and executing the manual re-binning manager 150 to perform the manual re-binning process.

The method 1100 can include an ACT 1120 of determining, by the data processing system 105, whether automatic re-binning or manual re-binning has been selected. The graphical user interface manager 115 can monitor the selection between the re-binning or manual re-binning process. The graphical user interface manager 115 can monitor the element 810 to determine whether a user, via the client device 110, has selected the automatic re-binning process or the manual re-binning process. The data processing system 105 can cause ACTS 1125 and 1130 to be performed responsive to determining that the automatic re-binning process has been selected. The data processing system 105 can cause ACTS 1125 and 1130 to be performed by the automatic re-binning manager 145 responsive to determining that the automatic re-binning process has been selected. The data processing system 105 can cause ACTS 1135 and 1140 to be performed responsive to determining that the manual re-binning process has been selected. The data processing system 105 can cause ACTS 1135 and 1140 to be performed by the manual re-binning manager 150 responsive to determining that the manual re-binning process has been selected.

The method 1100 can include an ACT 1125 of executing, by the data processing system 105, a process on an objective function weighted on a number of entries of a feature per bin to determine a piece-wise function. The objective function can be a summation of distances between a line of a piece-wise function and bins and coefficients of the indicator table 130. The objective function can be weighted on the number of entries of the feature of the indicator table 130. For example, the more entries of a feature for a particular bin, the higher the objective function can weigh the piece-wise function across the particular bin. Executing the process on the objective function can identify ranges for each function of the piece-wise function and types of each function. The process can be a computing process such as a Fibonacci search, a Golden Section Search, a Bisection Method, a gradient descent, nonlinear least squares, Newton's method, Secant method, Quasi-Newton method.

The method 1100 can include an ACT 1130 of generating, by the data processing system 105, a re-binned indicator table 155 based on the piece-wise function. Generating the re-binned indicator table 155 can include identifying ranges of the feature for bins for the re-binned indicator table 155. The data processing system 105 can have a maximum number of bins provided by a user via the client device 110. The data processing system 105 can assign ranges to each bin based on a slope or gradient of the piece-wise function. The higher the slope or gradient of the piece-wise function, the narrower range of the feature can be assigned to the bins. The lower the slope or gradient of the piece-wise function, the wider the range can be assigned to the bins. The data processing system 105 can determine a coefficient for each bin. The data processing system 105 can determine an average, maximum, or minimum of a level of a line of the piece-wise function across the bin. The average, maximum, or minimum can be the coefficient for the bin. The data processing system 105 can generate the re-binned indicator table 155 based on the bins and coefficients.

The method 1100 can include an ACT 1135 of receiving, by the data processing system 105, user defined parameters 135 via the graphical user interface 500. The data processing system 105 can receive the parameters 135 via the element 905. For example, a user, via the client device 110, can enter knots and spline types for spline pieces of a spline (e.g., ranges and function types for functions of a piece-wise function). The knots and spline types can be indicated in the element 915. The user can enter, via the client device 110, definitions of each bin for the re-binned indicator table 155.

The method 1100 can include an ACT 1140 of generating, by the data processing system 105, the re-binned indicator table 155 based on the parameters 135. The data processing system 105 can generate the piece-wise function based on the parameters 135. The parameters 135 can define parameters of the piece-wise function. The data processing system 105 can generate the coefficients for each bin based on the piece-wise function. The data processing system 105 can determine an average, maximum, minimum of a level of a line of the piece-wise function across the bin. The average, maximum, or minimum can be the coefficient for the bin. The data processing system 105 can generate the re-binned indicator table 155 based on the bins and coefficients.

The method 1100 can include an ACT 1145 of generating, by the data processing system 105, data causing the graphical user interface 500 to display the re-binned indicator table 155. For example, the data processing system 105 can cause the graphical representation 510 of the indicator table 130 to be replaced with a graphical representation 510 of the re-binned indicator table 155. The data processing system 105 can save the re-binned indicator table 155 as the indicator table for a particular feature. Responsive to a user selecting the particular feature, the data processing system 105 can cause the graphical user interface 500 to display the graphical representation 510 to display the re-binned indicator table 155. For example, responsive to receiving a selection of a feature via the list 505, the data processing system 105 can cause the graphical user interface 500 to display the graphic representation 510 of the re-binned indicator table 155 for the selected feature.

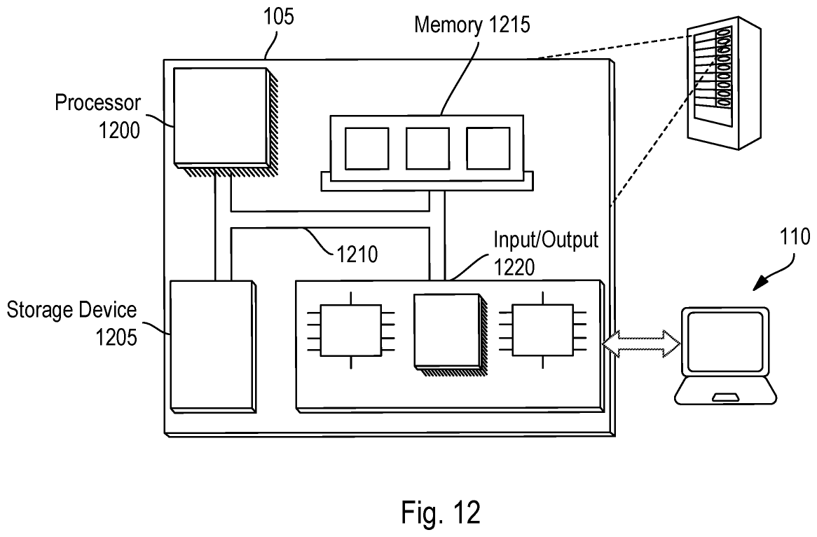

FIG. 12 is a block diagram of an example of the data processing system 105. The data processing system 105 can include or be a general-purpose computer, a network appliance, a mobile device, a server, a cloud computing system, or other electronic devices or systems. The data processing system 105 can include at least one processor 1200, at least one memory 1215, at least one storage device 1205, and at least one input/output device 1220. The processor 1200, the memory 1215, the storage device 1205, and the input/output device 1220 can be interconnected, for example, using at least one system bus 1210. The processor 1200 can process instructions for execution within the data processing system 105. The processor 1200 can include a single-threaded processor. The processor 1200 can include a multi-threaded processor. The processor 1200 can process instructions stored in the memory 1215 or on the storage device 1205.

The memory 1215 can store information within the data processing system 105. The memory 1215 can include a non-transitory computer-readable medium. The memory 1215 can include a volatile memory unit. The memory 1215 can include a non-volatile memory unit. The storage device 1205 can provide mass storage for the data processing system 105. The storage device 1205 can include a non-transitory computer-readable medium. The storage device 1205 can include a hard disk device, an optical disk device, a solid-date drive, a flash drive, or some other large capacity storage device. The storage device 1205 can store long-term data (e.g., database data, file system data, etc.). At least one input/output device 1202 can perform input/output operations for the data processing system 105. The input/output device 1220 can include one or more of a network interface devices, e.g., an Ethernet card, a serial communication device, e.g., an RS-232 port, and/or a wireless interface device, e.g., a Wi-Fi card (e.g., an 802.11 card), a 3G wireless modem, a 4G wireless modem, or a 5G wireless modem. In some implementations, the input/output device 1220 can include driver devices configured to receive input data and send output data to client devices 110, e.g., keyboard, printer and display devices, smartphones, laptops, tablets, desktop computers, printers, speakers, microphones, or other devices.

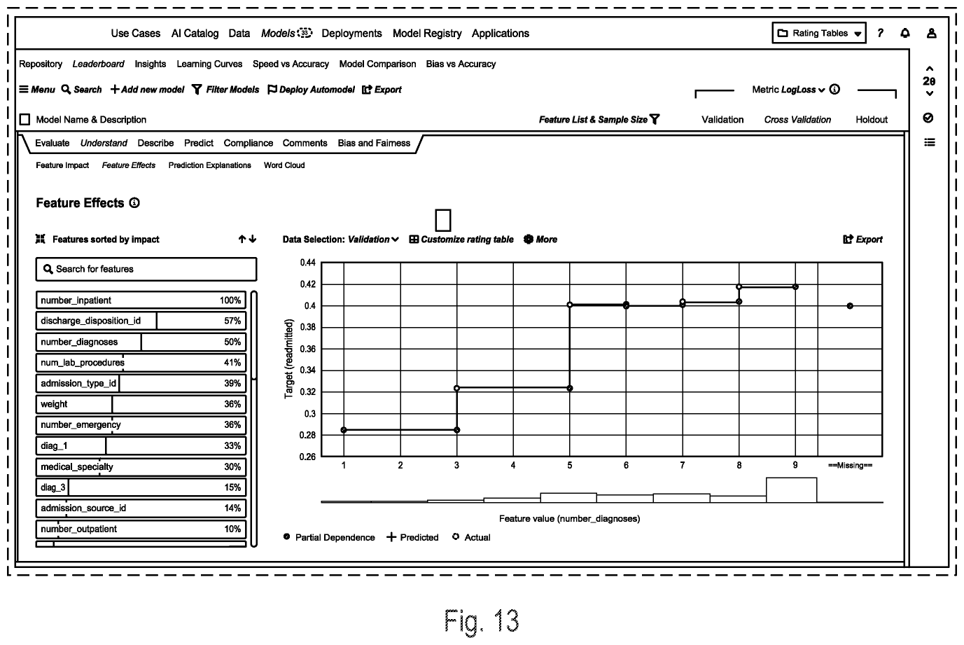

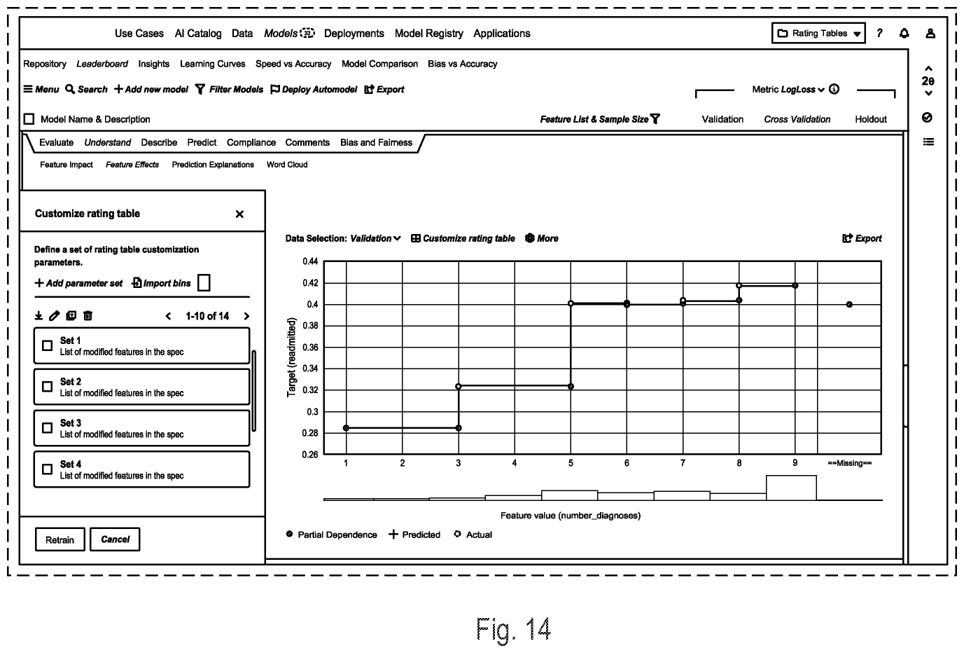

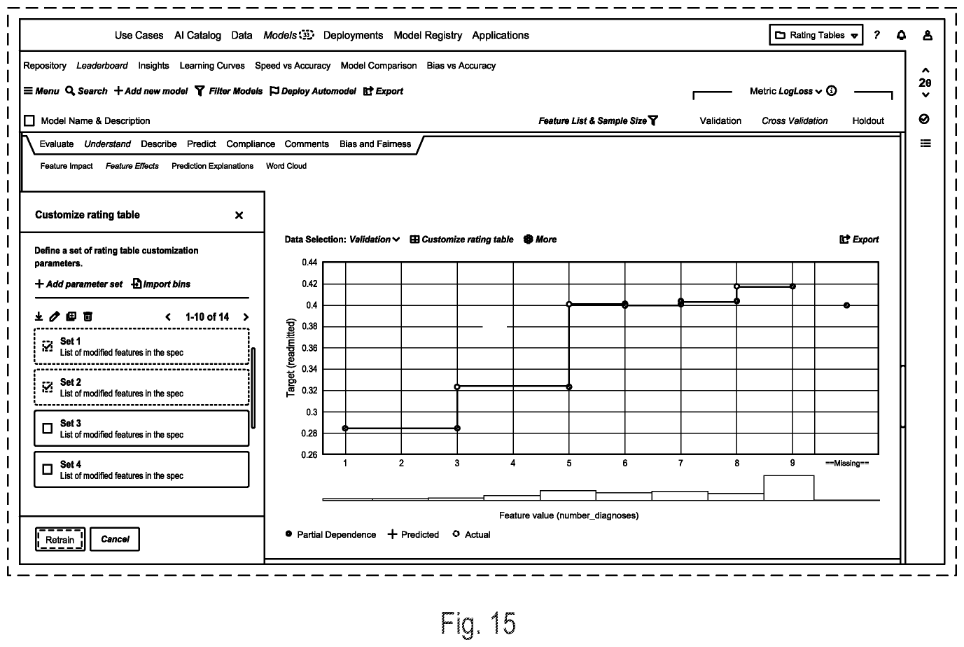

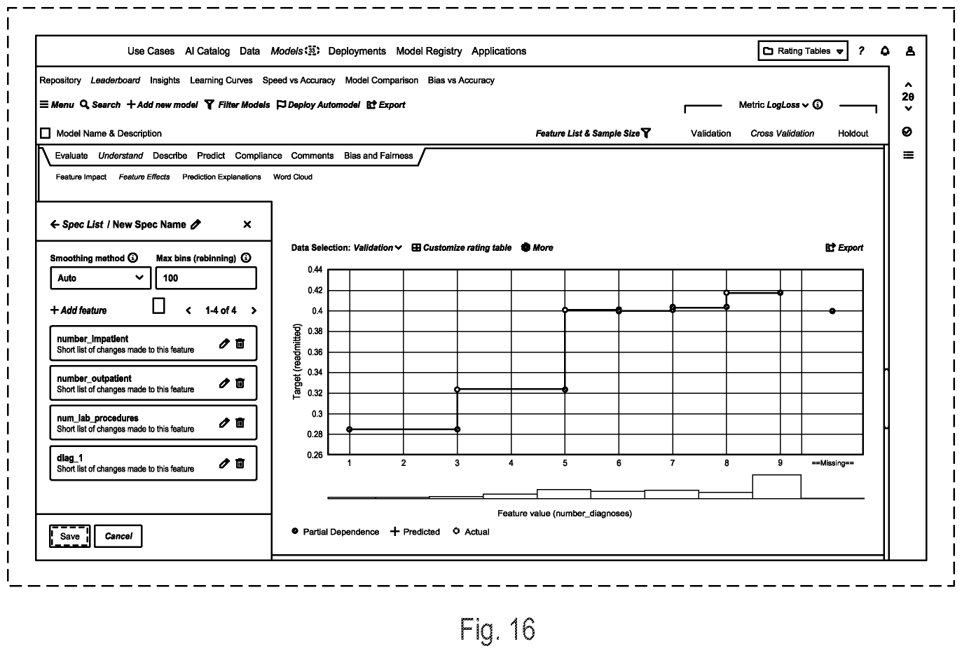

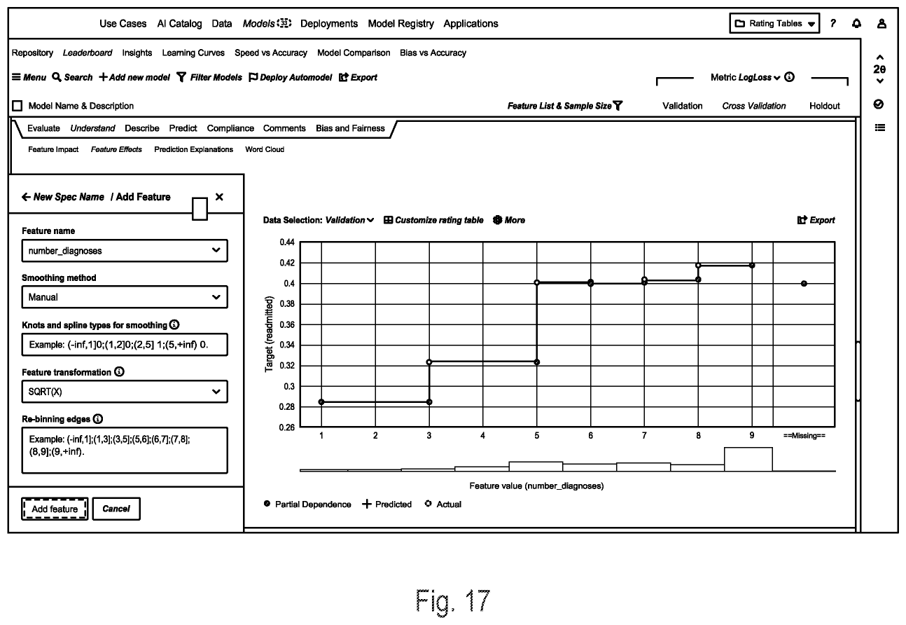

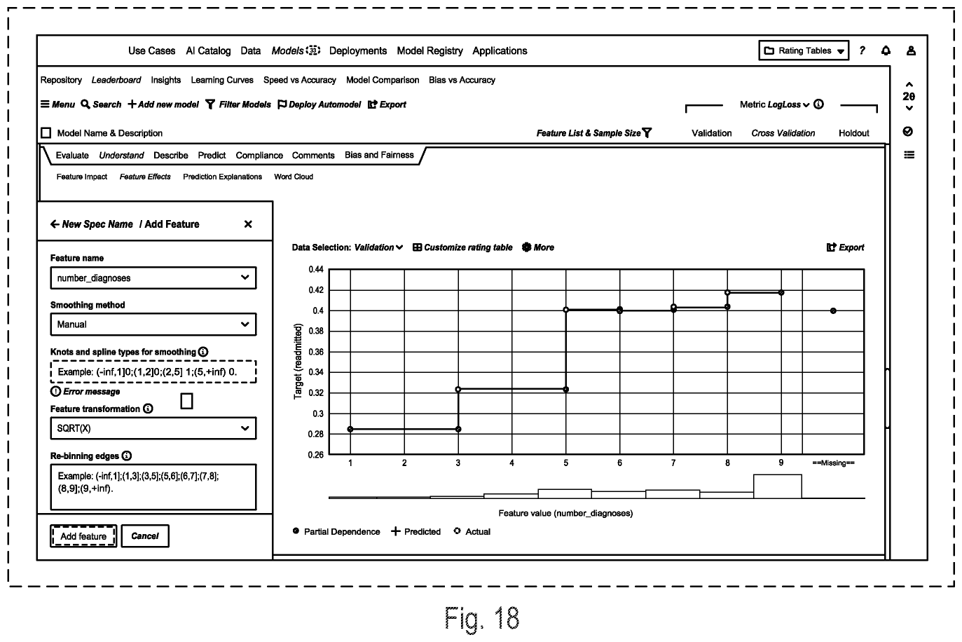

FIGS. 13-18 depict display screens or portions thereof with example graphical user interfaces. The outermost broken lines in FIGS. 13-18 illustrate the display screen or portion thereof. The graphical user interfaces may be generated, provided, and/or otherwise included with one or more embodiments described herein. Various modifications to the depicted graphical user interfaces are contemplated, such as certain of the depicted elements of one graphical user interface may be added to another graphical user interface, one or more depicted elements of certain graphical user interfaces may be removed, and/or other modifications (e.g., various graphical user interfaces may be linked together as a sequence of images to form an animated graphical user interface sequence). Further, the depicted graphical user interfaces may include various colors, color combinations, and/or other visual elements (e.g., textures, patterns, etc.) to illustrate contrasts in appearance. Moreover, modifications of the values of any depicted numbers, words, and letters is contemplated with such changes intended to fall within the scope of the disclosure. Thus, the depicted graphical user interfaces may have a variety of different appearances.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods can be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system, comprising:
a data processing system comprising one or more processors, coupled with memory, to:
identify a table generated by a model trained with machine learning, the table comprising a plurality of bins for ranges of values of a feature and a plurality of coefficients that indicate a level of a target for the plurality of bins;
receive, via a graphical user interface from a client device, a request to modify bins of the table;
establish, responsive to the request, a spline to fit the table based at least in part on a cost function weighted based on a number of entries of the feature for the ranges of values of the feature;
generate, via the spline established based at least in part on the cost function, a second table comprising a plurality of second bins and a plurality of second coefficients; and
generate data to cause the graphical user interface to include a graphic representation of the second table.

2. The system of claim 1, comprising the data processing system to:
generate a first bin for a first range of values of the feature of the plurality of second bins in a first resolution proportional to a first slope of the spline over the first range of values of the feature; and
generate a second bin for a second range of values of the feature of the plurality of second bins in a second resolution proportional to a second slope of the spline over the second range of values of the feature.

3. The system of claim 1, comprising the data processing system to:
fit the spline to the table based on the cost function, the cost function comprising:
a summation of distances between the plurality of second bins and lines of a plurality of functions of the spline.

4. The system of claim 1, comprising the data processing system to:
receive, via the graphical user interface from the client device, a first definition of a first set of parameters for a first feature;
receive, via the graphical user interface from the client device, a second definition of a second set of parameters for a second feature;
generate a first re-binned indicator table based on a first indicator table generated by machine learning for the first feature and the first set of parameters; and
generate a second re-binned indicator table based on a second indicator table generated by machine learning for the second feature and the second set of parameters.

5. The system of claim 1, the spline comprising at least one first function of a first function type and at least one second function of a second function type.

6. The system of claim 5, wherein the first function type is linear and the second function type is constant.

7. The system of claim 1, comprising the data processing system to:
receive, via the graphical user interface from the client device, a plurality of parameters defining the spline; and
generate the spline based on the plurality of parameters.

8. The system of claim 7, wherein the plurality of parameters include:
a plurality of ranges for functions of the spline; and
a plurality of function types for the plurality of ranges.

9. The system of claim 1, comprising the data processing system to:
generate data to cause the graphical user interface to include an element to select between an automatic generation of the second table and a manual generation of the second table.

10. The system of claim 9, comprising the data processing system to:
fit the spline to the table based on the cost function weighted based on the number of entries of the feature for the ranges of values of the feature responsive to a selection of the automatic generation by the client device via the graphical user interface.

11. The system of claim 9, comprising the data processing system to:
generate the spline based on a plurality of user defined parameters responsive to a selection of the manual generation of the second table.

12. The system of claim 11, comprising the data processing system to:
receive the plurality of user defined parameters in a first format;
compare the first format to a second format; and
generate data causing the graphical user interface to display an alert responsive to a determination of a difference between the first format and the second format.

13. A method, comprising:
identifying, by a data processing system comprising one or more processors, coupled with memory, a table generated by a model trained with machine learning, the table comprising a plurality of bins for ranges of values of a feature and a plurality of coefficients that indicate a level of a target for the plurality of bins;
receiving, by the data processing system, via a graphical user interface from a client device, a request to modify bins of the table;
establishing, by the data processing system, responsive to the request, a spline to fit the table based at least in part on a cost function weighted based on a number of entries of the feature for the ranges of values of the feature;
generating, by the data processing system, via the spline established based at least in part on the cost function, a second table comprising a plurality of second bins and a plurality of second coefficients; and
generating, by the data processing system, data to cause the graphical user interface to include a graphic representation of the second table.

14. The method of claim 13, comprising:
generating, by the data processing system, a first bin for a first range of values of the feature of the plurality of second bins in a first resolution proportional to a first slope of the spline over the first range of values of the feature; and
generating, by the data processing system, a second bin for a second range of values of the feature of the plurality of second bins in a second resolution proportional to a second slope of the spline over the second range of values of the feature.

15. The method of claim 13, comprising:
fitting, by the data processing system, the spline to the table based on the cost function, the cost function comprising:
a summation of distances between the plurality of second bins and lines of a plurality of functions of the spline.

16. The method of claim 13, comprising to:
receiving, by the data processing system, via the graphical user interface from the client device, a first definition of a first set of parameters for a first feature;
receiving, by the data processing system, via the graphical user interface from the client device, a second definition of a second set of parameters for a second feature;
generating, by the data processing system, a first re-binned indicator table based on a first indicator table generated by machine learning for the first feature and the first set of parameters; and
generating, by the data processing system, a second re-binned indicator table based on a second indicator table generated by machine learning for the second feature and the second set of parameters.

17. The method of claim 13, comprising the:
generating, by the data processing system, data to cause the graphical user interface to include an element to select between an automatic generation of the second table and a manual generation of the second table.

18. The method of claim 17, comprising:
fitting, by the data processing system, the spline to the table based on the cost function weighted based on the number of entries of the feature for the ranges of values of the feature responsive to a selection of the automatic generation by the client device via the graphical user interface.

19. One or more computer readable media storing instructions thereon, that, when executed by one or more processors, cause the one or more processors to:
identify a table generated by a model trained with machine learning, the table comprising a plurality of bins for ranges of values of a feature and a plurality of coefficients that indicate a level of a target for the plurality of bins;
receive, via a graphical user interface from a client device, a request to modify bins of the table;
establish, responsive to the request, a spline to fit the table based at least in part on a cost function weighted based on a number of entries of the feature for the ranges of values of the feature;
generate, via the spline established based at least in part on the cost function, a second table comprising a plurality of second bins and a plurality of second coefficients; and
generate data to cause the graphical user interface to include a graphic representation of the second table.

20. The one or more computer readable media of claim 19, the instructions cause the one or more processors to:
generate a first bin for a first range of values of the feature of the plurality of second bins in a first resolution proportional to a first slope of the spline over the first range of values of the feature; and
generate a second bin for a second range of values of the feature of the plurality of second bins in a second resolution proportional to a second slope of the spline over the second range of values of the feature.
